(19) United States
(12) Patent Application Publication
(10) Pub. No.: US 2005/0000645 A1
(43) Pub. Date: Jan. 6, 2005

(54) Method for bonding reinforcing plate

(75) Inventor: Katsuyuki Naitoh, Tenri-shi (JP)

Correspondence Address: NIXON & VANDERHYE, PC, 1100 N GLEBE ROAD, 8TH FLOOR, ARLINGTON, VA, 22201-4714, US

(73) Assignee: SHARP KABUSHIKI KAISHA, Osaka (JP)

(21) Appl. No.: 10/871,048

(22) Filed: Jun. 21, 2004

(30) Foreign Application Priority Data
Jul. 1, 2003 (JP) 2003-189641

(51) Int. Cl. B32B 31/00

(52) U.S. Cl. 156/307.5

(57) ABSTRACT

A method for bonding a reinforcing plate to a flexible substrate, the method comprising the steps of: laminating a sheet-shaped thermosetting adhesive on a plate-like polyimide resin to prepare a reinforcing plate; drying the reinforcing plate so that its water content is decreased to the maximum allowable level or less; bonding the reinforcing plate to the flexible substrate through the adhesive by thermocompression bonding; and actually curing the adhesive by heating.

### CROSS-REFERENCE TO RELATED APPLICATION

This application is related to Japanese application No. 2003-189641 filed on Jul. 1, 2003, whose priority is claimed under 35 USC § 119, the disclosure of which is incorporated by reference in its entirety.

### BACKGROUND OF THE INVENTION

1. Field of the Invention

The invention relates to a method for bonding a reinforcing plate and, more particularly, to a method for bonding a reinforcing plate to a flexible substrate used for a tape-carrier-package (TCP) or a chip-on-FPC (COF) which is one of packages for various electronic components such as a cellular phone, a personal digital assistance (PDA) and the like.

2. Description of the Related Art

A portable appliance such as a cellular phone, a PDA and the like is desirable to be made lightweight, thin, short and small and, for simplification of its assembly, it is preferable to make the respective functional units be modules.

For example, a liquid crystal module employed for a cellular phone comprises not only a liquid crystal driver installed by forming wiring in a flexible substrate but also various components such as semiconductor chips of the liquid crystal driver; semiconductor chips other than the liquid crystal driver, e.g., an SRAM and a controller; chip components, e.g., a capacitor and a resistor; and connectors. They are formed into a module.

In the assembly for application, the connection of a liquid crystal module and an external circuit is easily established by attachment/detachment of a connector. A reinforcing plate is bonded to the rear face of the connector with a flexible substrate interposed therebetween. At the time of attachment/detachment of the connector, the flexible substrate on which the connector is mounted is prevented from inconvenience such as deformation or damage due to mechanical load received by the flexible substrate.

The flexible substrate is finally subjected to punching with a die after respective steps for the outer shape formation.

In this case, if the reinforcing plate and the flexible substrate are punched together and the bonded part of the reinforcing plate is treated to match the edge parts of both of the substrate and the reinforcing plate even after the outer shape formation, no excess idle part of the flexible substrate exceeding the edge of the reinforcing plate is left. Therefore, inconvenience such as disconnection in the case where a wiring pattern exists in the idle part can be avoided.

In the case of punching the flexible substrate by a die for outer shape formation, if the adhesive of the reinforcing plate is a general adhesive, the adhesive is adhered to the punching die and accumulated. Finally, the punched flexible substrate is bonded to the die because of the adhesive to result in inconvenience that the die cannot be operated.

Accordingly, it is desirable to use a thermosetting adhesive for bonding the reinforcing plate to the flexible substrate. In the case of using the thermosetting adhesive, the adhesive is completely cured after the bonding of the reinforcing plate and does not have adhesive force; therefore, the above-mentioned inconvenience can be solved. Consequently, the reinforcing plate is required to have heat resistance. If the reinforcing plate is made of PET, it is deformed by heat; therefore, the material for the reinforcing plate is generally polyimide resin.

In the case of using the thermosetting adhesive for bonding the reinforcing plate, such inconvenience of the adhesive is not caused. On the other hand, the water in the reinforcing plate has to be removed at the time of bonding the reinforcing plate to the flexible substrate.

The inconvenience caused in the case where water is absorbed or adheres to the reinforcing plate containing the thermosetting adhesive will be described with reference to FIGS. 4A and 4B.

At the time of thermocompression bonding of a flexible substrate (105) and a reinforcing plate (1010), the water is evaporated, and the evaporated water (steam) is generated and remains in form of air bubbles (1020) in the interface between the flexible substrate (105) and the reinforcing plate (1010). The air bubbles (1020) are expanded by solder reflow for disposition-on-surface and make the surface of the flexible substrate (105) uneven to deteriorate the flatness of the mounting face of a connector (1021). Therefore, there arises a problem of so-called open failure that a terminal (1022) of the connector (1021) is separated from the surface of the flexible substrate (105).

As a conventional example of a reinforcing plate bonding method for solving the above-mentioned air bubbles, there is, for example, a method described in Japanese Unexamined Patent Publication No. Hei 7 (1995)-170032.

The summary of “reinforcing sheet sticking method of flexible printed wiring board” described in the above publication will be described in FIGS. 5 and 6.

As shown in FIG. 5, a flexible substrate (105) in an independent member state is laminated together with a reinforcing plate (1010) and a cushion member (1011), and the resulting laminate is treated as a set of a work and sandwiched between a top die (1012) and a bottom die (1013). Next, the work is set inside a box (1015) in which a vacuum seal (1014) is placed so as to prevent gas leakage during vacuum evacuation. Then, after a cover (1016) is closed, the box (1015) is vacuum evacuated by a vacuum pump (1017). At that time, as shown in FIG. 6, the box (1015) of which the cover (1016) is closed is heated while being pressurized in the direction of pressurizing the work by an upper die (1018) and a lower die (1019) of a heat press apparatus. Accordingly, the flexible substrate (105) and the reinforcing plate (1010) in the box (1015) can be bonded by thermocompression bonding.

That is, in order to prevent generation of air bubbles in the interface between the flexible substrate (105) and the reinforcing plate (1010), the vacuum environment is produced in the box (1015) and an adhesion interface in the box (1015) is heated and pressurized by the thermocompression bonding of the box (1015) itself, so that the reinforcing plate (1010) is bonded to the flexible substrate (105) without generating the air bubbles in the interface between the flexible substrate (105) and the reinforcing plate (1010).

The above-mentioned conventional technique aims to prevent the air bubbles from being generated in the interface between the flexible substrate and the reinforcing plate, wherein the work as an independent member placed in the vacuum-evacuated is laminated inside the box, and the reinforcing plate and the flexible substrate are thermocompression-bonded to each other.

By such a technique, the flexible substrate and the reinforcing plate can be pressure-bonded without requiring the thermocompression mechanism in the vacuum chamber and only by pressure-bonding the work in the box kept in the vacuum by a heat press in the box itself, so that the thermocompression bonding can be carried out in vacuum environments without using a large scale vacuum apparatus.

However, in the case of carrying but “reinforcing sheet sticking method of flexible printed wiring board” described in the above publication, every time when thermocompression bonding is carried out for one work, a series of steps: setting the work in the box, setting in the heat press, heat pressing, and taking out the work, which are the respective steps of the bonding have to be carried out.

Here, as a present flexible substrate for a TCP, a COF and the like, it is general to handle the substrate in form of a long tape-shaped state rolled in a reel in the production process. Today, automatic operation for carrying out continuous process by a reel-to-reel method of supply and recovery from a supply reel to a recovery reel becomes advantageous for mass production. Therefore, the above-mentioned conventional technique does not meet such present situation of handling the flexible substrate.

Even in the case where “reinforcing sheet sticking method of flexible printed wiring board” described in the above publication is not employed, a batch process cannot be employed for the bonding process of handling long tape-shaped ones.

### SUMMARY OF THE INVENTION

The invention is made in consideration of the above-mentioned situation and an object thereof is to provide a method for bonding a reinforcing plate, which is suitable for a reel-to-reel manner and which can prevent surface mounting failure due to air bubbles.

According to one aspect of the invention, there is provided a method for bonding a reinforcing plate to a flexible substrate, the method comprises the steps of: laminating a sheet-shaped thermosetting adhesive on a plate-like polyimide resin to prepare a reinforcing plate; drying the reinforcing plate so that its water content is decreased to the maximum allowable level or less; bonding the reinforcing plate to the flexible substrate through the adhesive by thermocompression bonding; and actually curing the adhesive by heating.

The method for bonding the reinforcing plate has a first feature in that the reinforcing plate comprising a sheet-shaped thermosetting adhesive laminated on the plate-like polyimide resin is prepared and, prior to the bonding of the reinforcing plate to a flexible substrate through the adhesive, the reinforcing plate is dried to decrease its water content to the allowable maximum value or less. The method has a second feature in that the heating is carried out so as to actually bond the reinforcing plate and the flexible substrate in the state that the unnecessary water is not left in the interface of the reinforcing plate and the flexible substrate.

The drying treatment in the first feature is carried out so as to previously remove water remaining in the interface between the reinforcing plate and the flexible substrate and forming air bubbles causing mounting-on-surface failure thereafter from the reinforcing plate. The heating treatment in the second feature is carried out so as to firmly bond both of the reinforcing plate and the flexible substrate in the condition that no unnecessary water remains.

According to the method for bonding the reinforcing plate, the water remaining on the interface between the reinforcing plate and the flexible substrate and forming air bubbles to lead to mounting-on-surface failure is removed previously before the reinforcing plate is bonded to the flexible substrate through the adhesive by the thermocompression bonding, so that possibility of the mounting-on-surface failure by air bubbles can be removed and thus the method is suitable for the reel-to-reel method.

### BRIEF DESCRIPTION OF THE DRAWINGS

FIG. 1 is a flowchart for describing a method for bonding a reinforcing plate according to the invention;

FIG. 2 is a schematic diagram of a main part of a reinforcing plate bonding apparatus for embodying the method for bonding the reinforcing plate according to the invention;

FIG. 3 is a diagram of the reinforcing plate set on a wafer ring in a reinforcing plate supply mechanism of the reinforcing plate bonding apparatus shown in FIG. 2;

FIG. 4A is a cross-sectional view showing a state where air bubbles remain in the interface of the flexible substrate in a conventional reinforcing plate bonding method, and FIG. 4B is a cross-sectional view of a main part showing the open failure of a connector terminal due to expansion of the air bubbles remaining as shown in FIG. 4A when the connector terminal is loaded into a reflow furnace for mounting-on-surface;

FIG. 5 is a cross-sectional view showing a conventional method for bonding a reinforcing plate; and

FIG. 6 is a cross-sectional view showing a thermocompression bonding state in the conventional method for bonding the reinforcing plate.

### DESCRIPTION OF THE PREFERRED EMBODIMENTS

The drying is preferably carried out in a vacuum defoaming apparatus. It is because the above-mentioned thermocompression bonding and heating treatment can be carried out successively after the drying treatment.

It is preferable that as conditions of the drying treatment, the vacuum degree of the vacuum chamber in the vacuum defoaming apparatus is 25 to 75 cmHg, the temperature is a normal temperature or slightly higher than that, and the treatment time is 6 to 18 hours. They are based on the fact that good results of drying treatment are obtained by experiments carried out in such conditions by the inventors.

The above-mentioned thermocompression bonding is preferably carried out by an automatic reinforcing plate bonding apparatus for carrying out work treatment by successively sending a long tape-shaped flexible substrate by the reel-to-reel method from a supply reel to a recovery reel. It is because the method is advantageous in terms of mass production.

It is preferable that as conditions of the thermocompression bonding, the surface temperature of a thermocompression bonding tool provided between the supply reel and the recovery reel is 120 to 240° C., the thermocompression bonding load is 20 to 35 kg/cm², and the thermocompression bonding time is 1 to 5 seconds. They are based on the fact that good results of drying treatment are obtained by experiments carried out in such conditions by the inventors.

The conditions of the heating treatment are preferably as that the heating temperature is 100 to 150° C. and the heating time is 4 to 8 hours. They are based on the fact that good results of drying treatment are obtained by experiments carried out in such conditions by the inventors.

According to another aspect of the invention, there is provide a method for bonding a reinforcing plate to a flexible substrate, the method comprises the steps of: preparing a polyimide resin reinforcing plate coated with an adhesive and previously subjected to drying treatment at a normal temperature or slightly higher than that in vacuum condition; continuously or intermittently sending a long tape-shaped flexible substrate to a pressure-bonding part while sending the reinforcing plate to a predetermined position of the pressure-bonding part; superposing the reinforcing plate and flexible substrate by pressure; heating the resultant laminate simultaneously with or immediately after the superposing; and carrying out thermocompression bonding of the reinforcing plate and the flexible substrate.

The method for bonding the reinforcing plate has a first feature in that the polyimide resin reinforcing plate coated with an adhesive is prepared and previously subjected to drying treatment at a normal temperature or slightly higher in vacuum condition. The method has a second feature in that the thermocompression bonding of the reinforcing plate (the reinforcing plate already subjected to the drying treatment) and a long tape-shaped flexible substrate by continuously or intermittently sending the flexible substrate to a pressure-bonding part and simultaneously sending the reinforcing plate to a predetermined position of the pressure-bonding part, laminating the reinforcing plate and flexible substrate by pressure, and heating the laminate simultaneously with or immediately after the laminating.

The drying treatment in the first feature is carried out so as to previously remove water remaining in the interface between the reinforcing plate and the flexible substrate and forming air bubbles causing mounting-on-surface failure thereafter from the reinforcing plate. The respective treatment steps of the thermocompression bonding of the reinforcing plate (the reinforcing plate already subjected to the drying treatment) and the long tape-shaped flexible substrate comprising sending the flexible substrate to pressure-bonding part and sending the reinforcing plate to a prescribed position of the pressure-bonding part, laminating the reinforcing plate and flexible substrate by pressure, and heating and press-bonding the laminate in the second feature are carried out so as to firmly and continuously bond both of the reinforcing plate and the flexible substrate in the condition that no unnecessary water remains.

According to the method for bonding the reinforcing plate, since water remaining in the interface of the reinforcing plate and the flexible substrate and forming air bubbles causing mounting-on-surface failure thereafter can be removed from the reinforcing plate before the reinforcing plate is bonded to the flexible substrate with the adhesive by heating and pressure-bonding, the method can remove the possibility of occurrence of the mounting-on-surface failure because of air bubbles and suitable for the reel-to-reel method.

It is preferable that the reinforcing plate is composed of a plurality of sheets with a predetermined shape and supplied to the pressure-bonding part while being set on one supporting paper sheet. Because it is advantageous for mass production.

The above-mentioned adhesive is preferably a thermosetting adhesive or a pressure sensitive adhesive. In the case of the thermosetting adhesive, it is cured by heating and in the case of the pressure sensitive adhesive, the adhesion ability is exhibited by applied pressure, so that either one may be selected in consideration of the treatment abilities, conditions, and cost of a variety of treatment apparatuses.

One embodiment of the invention will be described with reference to the attached drawings. The invention is not limited to the embodiment.

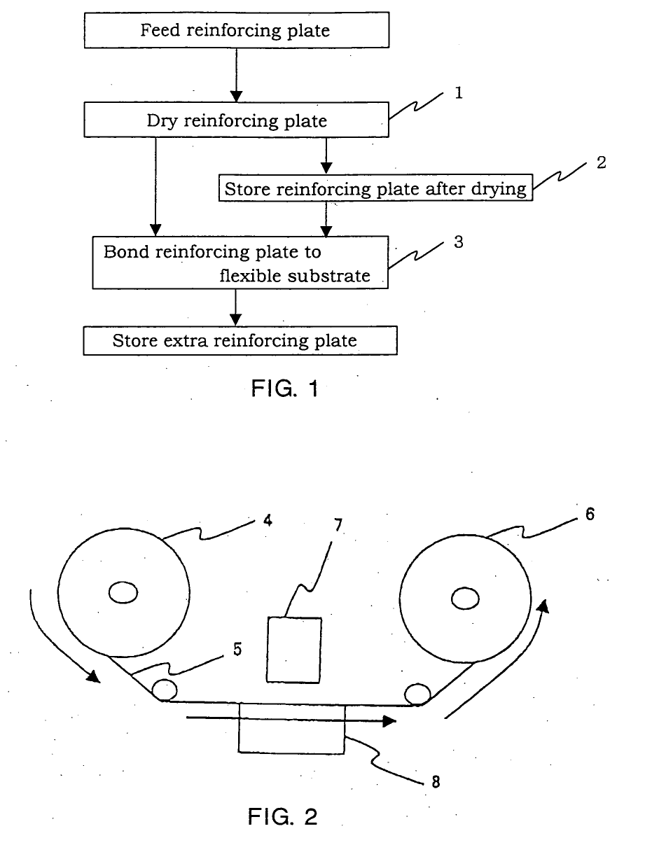

FIG. 1 shows a flowchart for describing the main process of the invention.

As shown in FIG. 1, at first, a reinforcing plate is fed. The reinforcing plate is obtained by laminating a sheet-shaped thermosetting adhesive on a plate-shaped polyimide (PI) resin. The fed reinforcing plate is, in a drying step (1) of the reinforcing plate, previously dried by a vacuum defoaming apparatus having a vacuum chamber to remove the water to the allowable maximum value or less.

Based on the results of experiments carried out previously, the inventors have found that 12 hours have taken to dry 100 sheets of supporting paper on which each 70 (10 pieces×7 rows) rectangular reinforcing plates having an outer size of 10 mm×15 mm (PI thickness: 175 umt) are arranged in a vacuum chamber at 50 cmHg vacuum degree, that is the time thereafter the water content is not decreased further from a constant value, the above-mentioned the allowable maximum value.

Further, the inventors also have found that the reinforcing plate again absorbs moisture by being left in air during the process, however under the environments of the relative humidity 55% or less, if the reinforcing plate already subjected to the drying treatment is bonded to the flexible substrate in 6 hours after the drying treatment, no air bubble which causes welding connection failure in the mounting-on-surface of the connector remains in the interface between the reinforcing plate and the flexible substrate.

However, as a practical problem, it is difficult to use up the already dried reinforcing plate in 6 hours after the drying treatment in terms of the line work, a step (2) of storage after drying for storing already dried reinforcing plate is required. The reinforcing plate which is subjected to the drying treatment however unused or the reinforcing plate left during the use is stocked in the dry storage housing in the step (2) of storage after drying.

The inventors have found if it is within 6 hours as integrated time after the reinforcing plate is taken out of the dry storage housing, no mounting-on-surface failure is caused. Incidentally, it is of course true that the above-mentioned drying treatment is carried out again, it gives 6 extra hours.

FIG. 2 is a schematic diagram of a main part of the reinforcing plate bonding apparatus to be employed in the step (3) of bonding the reinforcing plate dried by the vacuum defoaming apparatus.

The reinforcing plate bonding apparatus has the same structure as an inner lead bonder for mounting a semiconductor chip on a general TCP or COF, which is a long tape-shaped flexible substrate 5 reeled on (a supply reel 4 and a recovery reel 6) and is usable for reel-to-reel treatment.

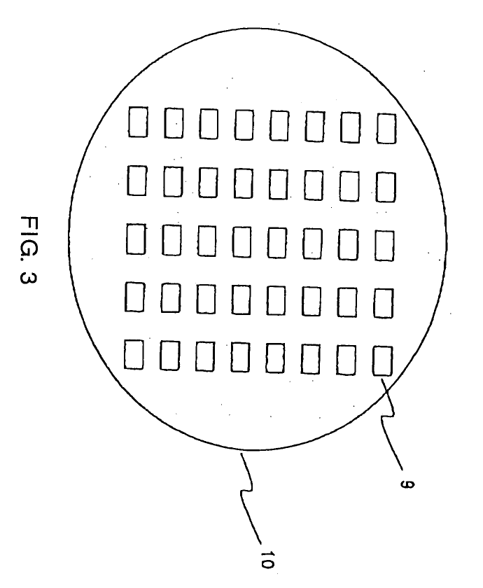

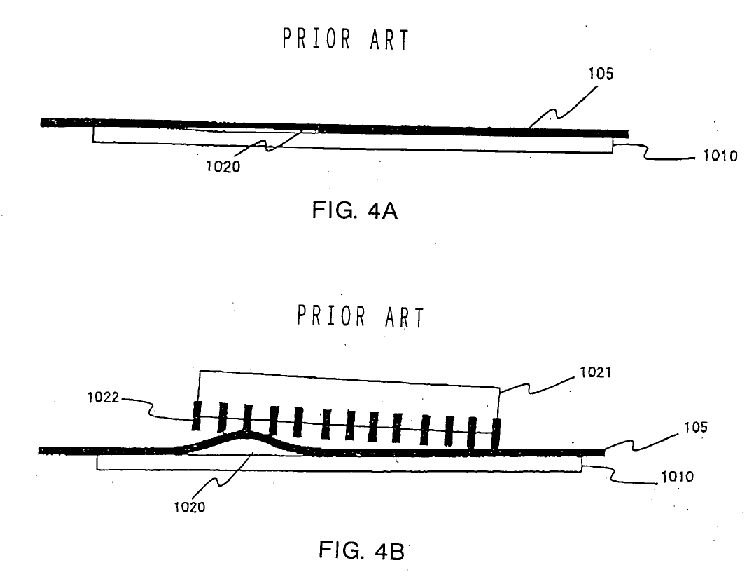

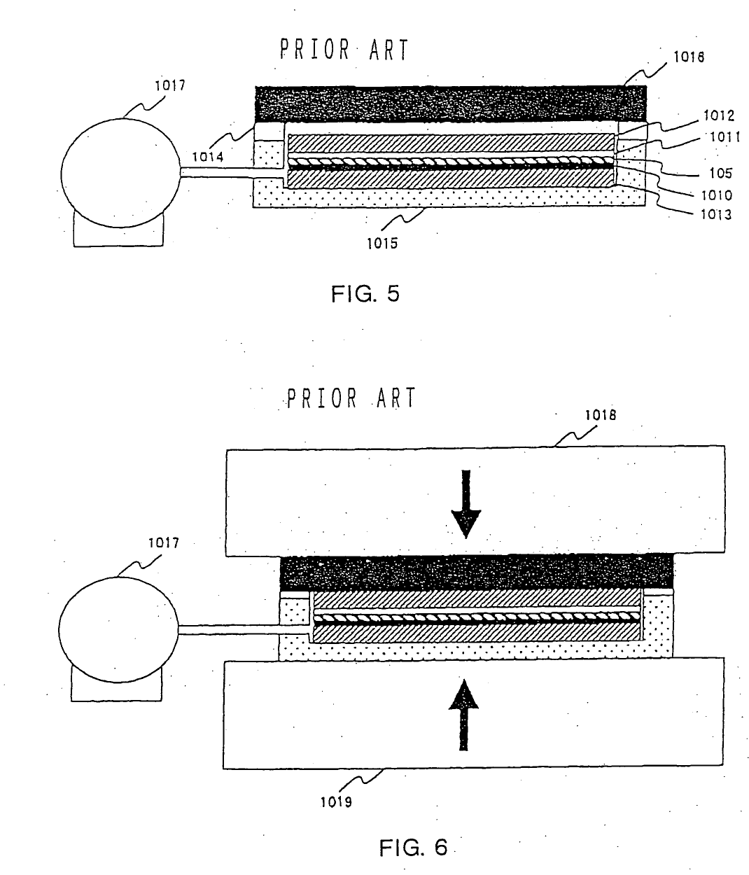

During the time that the long tape-shaped flexible substrate 5 is unreeled from the supply reel 4 and recovered on the recovery reel 6, in place of a chip, the reinforcing plate 10 matrix-positioned on a wafer ring 9 shown in FIG. 3 is placed on a compression bonding stage 8 by a picking-up and placing step by the compression bonding tool 7 and the compression bonding stage 8, which compose the compression bonding part of the reinforcing plate bonding mechanism formed between the supply reel 4 and the recovery reel 6. Next, the reinforcing plate 10 is bonded to the rear face of the flexible substrate 5 by thermocompression bonding by the tool 7 and the stage 8.

However, the thermocompression bonding is not by main actual bonding with the thermosetting adhesive but the temporary compression boding for temporarily bonding the reinforcing plate 10 to the flexible substrate 5. The inventors have found that no air bubble which causes the mounting-on-surface failure is generated if the surface temperature of the tool 7 is 200° C., the surface temperature of the stage 8 is 150° C., the compression bonding load is 28 kg/cm², and the compression boding time is 3 seconds.

After that, in order to carry out the main actual bonding with the adhesive, the resulting laminate is kept at 125° C. for 6 hours. Next, in the mounting-on-surface after the main actual bonding with the adhesive, the inventors have found that welding failure is not caused in the connector on the reinforcing plate 10.

Accordingly, the reinforcing plate 10 can be bonded to the flexible substrate 5 by automatic reel-to-reel operation without being accompanied with a problem of component mounting failure.

1. A method for bonding a reinforcing plate to a flexible substrate, the method comprising the steps of:
laminating a sheet-shaped thermosetting adhesive on a plate-like polyimide resin to prepare a reinforcing plate;
drying the reinforcing plate so that its water content is decreased to the maximum allowable level or less;
bonding the reinforcing plate to the flexible substrate through the adhesive by thermocompression bonding; and
actually curing the adhesive by heating.

2. The method of claim 1, wherein
the drying is carried out in a vacuum defoaming apparatus.

3. The method of claim 2, wherein
the drying is carried out in conditions of: 25 to 75 cmHg of a vacuum degree in a vacuum chamber of the vacuum defoaming apparatus; a normal temperature or a slightly higher temperature than that; and 6 to 18 hours of a treatment duration.

4. The method of claim 1, wherein
the thermocompression bonding is carried out in an automatic reinforcing plate bonding apparatus for carrying out work treatment by successively supplying a long tape-shaped flexible substrate from a supply reel to a recovery reel in reel-to-reel manner.

5. The method of claim 4, wherein
the thermocompression bonding is carried out in conditions of: 120 to 240° C. of a surface temperature of a thermocompression bonding tool provided between the supply reel and the recover reel; 20 to 35 kg/cm² of a thermocompression bonding load; and 1 to 5 seconds of a thermocompression bonding time.

6. The method of claim 1, wherein
the heating is carried out in conditions of: 100 to 150° C. of a heating temperature; and 4 to 8 hours of a heating time.

7. A method for boning a reinforcing plate to a flexible substrate, the method comprising the steps of:
preparing a polyimide resin reinforcing plate coated with an adhesive and previously subjected to drying treatment at a normal temperature or slightly higher temperature than that in vacuum condition;
continuously or intermittently sending a long tape-shaped flexible substrate to a pressure-bonding part while sending the reinforcing plate to a predetermined position of the pressure-bonding part;
superposing the reinforcing plate and the flexible substrate by pressure;
heating the resultant laminate simultaneously with or immediately after the superposing; and
carrying out thermocompression bonding of the reinforcing plate and the flexible substrate.

8. The method of claim 7, wherein
the reinforcing plate is composed of a plurality of sheets with a prescribed shape and supplying the reinforcing plate to the pressure-bonding part while placing the plate on one sheet of a supporting paper sheet.

9. The method of claim 7, wherein
the adhesive is a thermosetting adhesive.

10. The method of claim 7, wherein
the adhesive is a pressure sensitive adhesive.
